(19) United States
(12) Patent Application Publication
(10) Pub. No.: US 2023/0317928 A1
(43) Pub. Date: Oct. 5, 2023

(54) Positive Electrode and Battery

(71) Applicant: Prime Planet Energy & Solutions, Inc., Tokyo (JP)

(72) Inventors: Kouhei MASAI, Kobe-shi (JP); Ryo HANAZAKI, Kobe-shi (JP); Akira TSUJIKO, Kobe-shi (JP)

(21) Appl. No.: 18/179,365

(22) Filed: Mar. 7, 2023

(30) Foreign Application Priority Data
Mar. 10, 2022 (JP) 2022-036829

(51) Int. Cl. H01M 4/36; H01M 4/131; H01M 4/505; H01M 4/525

(52) U.S. Cl. CPC H01M 4/366; H01M 4/131; H01M 4/505; H01M 4/525; H01M 2004/028

(57) ABSTRACT

The present disclosure relates to a positive electrode comprising a positive electrode active material layer and a positive electrode base material, wherein the positive electrode active material layer includes a positive electrode active material, the positive electrode active material includes a layered metal oxide, the ratio of nickel to the total amount of nickel and a transition metal in the layered metal oxide is 70% or more, and the positive electrode active material present near a surface of the positive electrode active material layer closer to the positive electrode base material has a crystallite diameter that is 200 Å to 500 Å greater than the positive electrode active material present near a surface of the positive electrode active material layer opposite to the positive electrode base material. According to the present disclosure, a positive electrode and a battery each of which is excellent in both endurance and efficiency are provided.

This nonprovisional application is based on Japanese Pat. Application No. 2022-036829 filed on Mar. 10, 2022, with the Japan Pat. Office, the entire contents of which are hereby incorporated by reference.

### BACKGROUND OF THE INVENTION

### Field of the Invention

The present disclosure relates to a positive electrode and a battery.

### Description of the Background Art

Japanese Pat. Laying-Open No. 2016-207479 suggests that, in a positive electrode active material for a non-aqueous electrolyte secondary battery including lithium-nickel composite oxide, for the purpose of enhancing cycling performance and high-temperature storage properties while maintaining a high capacity, the crystallite diameter can be designed to fit within the range of 100 nm to 130 nm and Mg can be added to increase the Li/Me ratio.

### SUMMARY OF THE INVENTION

Conventionally, a Hi-Ni-type positive electrode active material having a small crystallite diameter can reduce particle breakage in Hi-Ni-type that may occur due to charge and discharge, but it has a large specific surface area as compared to an active material having a large crystallite diameter and thereby may cause a decrease of initial efficiency. In contrast, a Hi-Ni-type positive electrode active material having a large crystallite diameter has a high initial efficiency as compared to a material having a small crystallite diameter, but it is likely to experience particle breakage due to charge and discharge and thereby may cause a decrease of endurance.

An object of the present disclosure is to provide a positive electrode and a battery each of which is excellent in both endurance and efficiency, by positioning a high-endurance material having a small crystallite diameter that is less likely to experience particle breakage, on a surface layer side which is frequently in contact with electrolyte solution and which is likely to experience particle breakage due to side reaction, and by positioning a material having a large crystallite diameter that can be efficiently charged and discharged, on a base material side.

The present disclosure provides a positive electrode and a battery described below.

A positive electrode comprising a positive electrode active material layer and a positive electrode base material, wherein the positive electrode active material layer includes a positive electrode active material, the positive electrode active material includes a layered metal oxide, a ratio of nickel to metallic elements except lithium in the layered metal oxide is 70 mol % or more, a part of the positive electrode active material present near a surface of the positive electrode active material layer closer to the positive electrode base material has a crystallite diameter that is 200 Å to 500 Å greater than a part of the positive electrode active material present near a surface of the positive electrode active material layer opposite to the positive electrode base material.

The positive electrode according to [1], wherein the layered metal oxide is represented by a formula (1): Li₁₋ₐNiₓMe₁₋ₓO₂, where a satisfies a relationship of -0.3≤a≤0.3, X satisfies a relationship of 0.7≤x≤1.0, and Me stands for at least one selected from the group consisting of Co, Mn, Al, Zr, B, Mg, Fe, Cu, Zn, Sn, Na, K, Ba, Sr, Ca, W, Mo, Nb, Ti, Si, V, Cr, and Ge.

The positive electrode according to [1] or [2], wherein the positive electrode active material layer includes a first positive electrode active material layer and a second positive electrode active material layer, and the second positive electrode active material layer is positioned close to the positive electrode base material as compared to the first positive electrode active material layer.

The positive electrode according to [3], wherein a thickness of the second positive electrode active material layer is defined as T2, a thickness of the first positive electrode active material layer is defined as T1, and a ratio of T1 to T2 (T1/T2) is from 0.33 to 3.0.

A battery comprising the positive electrode according to any one of [1] to [4].

The foregoing and other objects, features, aspects and advantages of this disclosure will become more apparent from the following detailed description of this disclosure when taken in conjunction with the accompanying drawings.

### BRIEF DESCRIPTION OF THE DRAWINGS

FIG. 1 is a schematic view illustrating an example configuration of a positive electrode according to the present embodiment.

FIG. 2 is a schematic flowchart illustrating a method of producing a positive electrode.

FIG. 3 is a schematic view illustrating an example configuration of a battery according to the present embodiment.

FIG. 4 is a schematic view illustrating an example configuration of an electrode assembly according to the present embodiment.

### DESCRIPTION OF THE PREFERRED EMBODIMENTS

In the following, a description will be given of embodiments of the present disclosure. In the embodiments described below, when a number, amount, and/or the like is referred to, the scope of the present disclosure is not necessarily limited to the number, amount, and/or the like unless otherwise specified.

### Positive Electrode

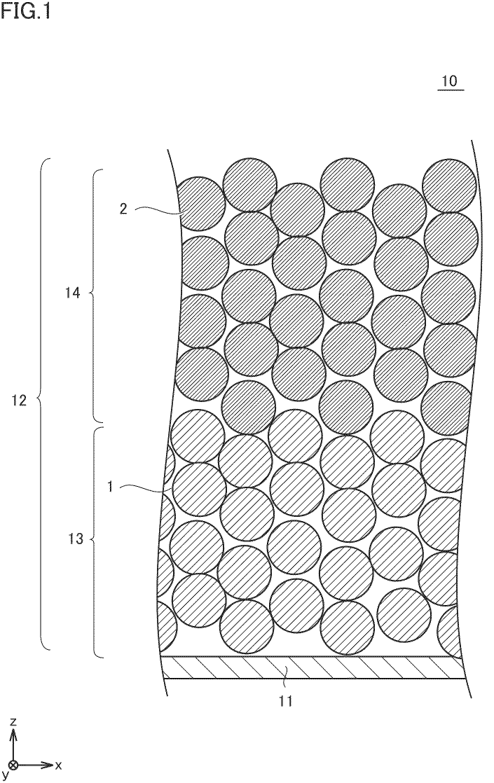

FIG. 1 is a schematic view illustrating an example configuration of a positive electrode according to the present embodiment. A positive electrode 10 includes a positive electrode base material 11 and a positive electrode active material layer 12, for example. Positive electrode base material 11 is a conductive sheet. Positive electrode base material 11 may be Al alloy foil and/or the like, for example. Positive electrode base material 11 may have a thickness from 10 µm to 30 µm, for example. The thickness of positive electrode base material 11 may be measured with a constant-pressure thickness-measuring instrument (a thickness gauge). Positive electrode active material layer 12 may be placed on the surface of positive electrode base material 11. For example, positive electrode active material layer 12 may be placed on only one side of positive electrode base material 11. For example, positive electrode active material layer 12 may be placed on both sides of positive electrode base material 11.

Positive electrode active material layer 12 may have a thickness from 10 µm to 200 µm, for example. The thickness of positive electrode active material layer 12 is measured in a cross-sectional SEM image of positive electrode active material layer 12. The plane to be observed may be parallel to a thickness direction of positive electrode active material layer 12. The thickness of a layer is measured at five or more positions. The arithmetic mean of the five or more thicknesses is adopted.

Positive electrode active material layer 12 includes a positive electrode active material. That is, positive electrode 10 includes a positive electrode active material. Positive electrode active material layer 12 includes a positive electrode active material 1 near a surface thereof closer to positive electrode base material 11 and includes a positive electrode active material 2 near a surface thereof opposite to positive electrode base material 11. Positive electrode active material 1 has a crystallite diameter that is 200 Å to 500 Å greater than the crystallite diameter of positive electrode active material 2. The crystallite diameter of positive electrode active material 1 may be 200 Å, 300 Å, 400 Å, or 500 Å greater than the crystallite diameter of positive electrode active material 2, for example.

The crystallite diameter of the positive electrode active material is calculated by an equation (i): D = Kλ/(βcosθ). This equation (i) is also called “the Scherrer equation”. In the equation (i), “D” represents crystallite diameter. “K” represents shape factor. In the present embodiment, K = 0.9. “λ” represents X-ray wavelength. “β” represents FWHM of a target diffraction peak. The unit of FWHM is radian. “θ” represents the Bragg angle of a target diffraction peak.

“β” and “θ” are determined from XRD profile. On a surface of a glass sample plate, a positive electrode active material (powder) is placed. During measurement, the sample is covered with a resin film and/or the like, for example, so as to avoid exposure of the sample to air. The XRD measurement conditions are, for example, as follows: Measurement temperature being 20° C.±5° C., X-ray source being Cu-Kα ray (wavelength, λ = 1.5418 Å), Detector being LYNX EYE (manufactured by Bruker), X-ray output being 40 kV × 40 mA, Goniometer radius being 250 mm, Measurement mode being continuous, Counting unit being cps, Scanning speed being 0.03 °/s, Measurement start angle being 10°, and Measurement end angle being 120°. From the XRD profile, FWHM (β) of 104 diffraction peak and Bragg angle (θ) of 104 diffraction peak are determined. The values “λ”, “β”, and “θ”are substituted into the above expression (V) to determine the crystallite diameter.

The crystallite diameter of positive electrode active material 1 may be, for example, from 1000 Å to 1800 Å (from 100 nm to 180 nm), preferably from 1100 Å to 1600 Å, more preferably from 1200 Å to 1400 Å. The crystallite diameter of positive electrode active material 2 may be, for example, from 1200 Å to 2000 Å (from 120 nm to 200 nm), preferably from 1300 Å to 1900 Å, more preferably from 1400 Å to 1900 Å. The crystallite diameter of positive electrode active material 1, 2 may be adjusted by adjusting the temperature at the time of calcination of positive electrode active material 1, 2, for example. The crystallite diameter of positive electrode active material 1, 2 depends on the calcination temperature, and the higher the calcination temperature is, the larger the crystallite diameter tends to become.

Positive electrode active material layer 12 includes a first positive electrode active material layer 13 and a second positive electrode active material layer 14, and second positive electrode active material layer 14 may be positioned closer to positive electrode base material 11 than first positive electrode active material layer 13 is to the latter. Positive electrode active material layer 12 may have a double-layer structure consisting of first positive electrode active material layer 13 and second positive electrode active material layer 14. First positive electrode active material layer 13 may include positive electrode active material 1, preferably may include positive electrode active material 1 without including positive electrode active material 2. Second positive electrode active material layer 14 may include positive electrode active material 2, preferably may include positive electrode active material 2 without including positive electrode active material 1.

First positive electrode active material layer 13 and second positive electrode active material layer 14 may have the same thickness, or may have different thicknesses, and each of them may have a thickness from 5 µm to 195 µm, for example. When the thickness of first positive electrode active material layer 13 is defined as T1 and the thickness of second positive electrode active material layer 14 is defined as T2, the ratio of T1 to T2 (T1/T2) may be from 0.33 to 3.0, for example. T1 and T2 are measured in the same manner as for the thickness of positive electrode active material layer 12.

Positive electrode active material 1, 2 includes a layered metal oxide. The layered metal oxide includes nickel and a transition metal. The ratio of nickel to metallic elements except lithium in the layered metal oxide is 70 mol % or more, preferably 75 mol % or more, more preferably 80 mol % or more, further preferably 85 mol % or more, and may be, for example, less than 100 mol %, or 95 mol % or less.

The layered metal oxide is represented by a formula (1): Li₁₋ₐNiₓMe₁₋ₓO₂, where a satisfies a relationship of -0.3≤a≤0.3, X satisfies a relationship of 0.7≤x≤1.0, and Me stands for at least one selected from the group consisting of Co, Mn, Al, Zr, B, Mg, Fe, Cu, Zn, Sn, Na, K, Ba, Sr, Ca, W, Mo, Nb, Ti, Si, V, Cr, and Ge. This ratio (mol%) of nickel to metallic elements except lithium in the layered metal oxide may be a value “x” in the formula (1) multiplied by 100. The layered metal oxide may include, for example, at least one selected from the group consisting of LiNi_{0.8}Co_{0.1}Mn_{0.1}O₂, LiNi_{0.7}Co_{0.2}Mn_{0.1}O₂, and LiNi_{0.7}Co_{0.1}Mn_{0.2}O₂.

Positive electrode active material 1, 2 may include an aggregated particle (a secondary particle) consisting of primary particles. When positive electrode active material 1, 2 includes an aggregated particle, the primary particles and the aggregated particle may have substantially the same chemical composition, or may have different chemical compositions. The primary particle may have a film adhered to the surface thereof. The film includes a metallic element. The film may consist essentially of a metallic element. The metallic element may include, for example, at least one selected from the group consisting of Al, B, Ti, and Y. The film may further include a non-metallic element (such as oxygen, carbon, and/or fluorine, for example).

When positive electrode active material 1, 2 includes an aggregated particle, the BET specific surface area of positive electrode active material 1, 2 may be from 0.5 m²/g to 1.5 m²/g, for example. When positive electrode active material 1, 2 includes an aggregated particle, positive electrode active material 1, 2 may have a D50 from 10 µm to 20 µm, for example. Herein, “D50” is defined as a particle size in volume-based particle size distribution at which cumulative frequency of particle sizes accumulated from the small size side reaches 50%. The volume-based particle size distribution may be measured with a laser-diffraction particle size distribution analyzer.

Positive electrode active material layer 12 may further include a conductive material, a binder, and/or the like, for example. The conductive material may be, for example, carbon black, fibrous carbon, and/or the like. For example, positive electrode active material layer 12 may consist essentially of a binder in an amount from 0.1% to 10% and a conductive material in an amount from 0.1% to 10% in terms of mass fraction, with the remainder being made up of the positive electrode active material.

### Method of Producing Positive Electrode

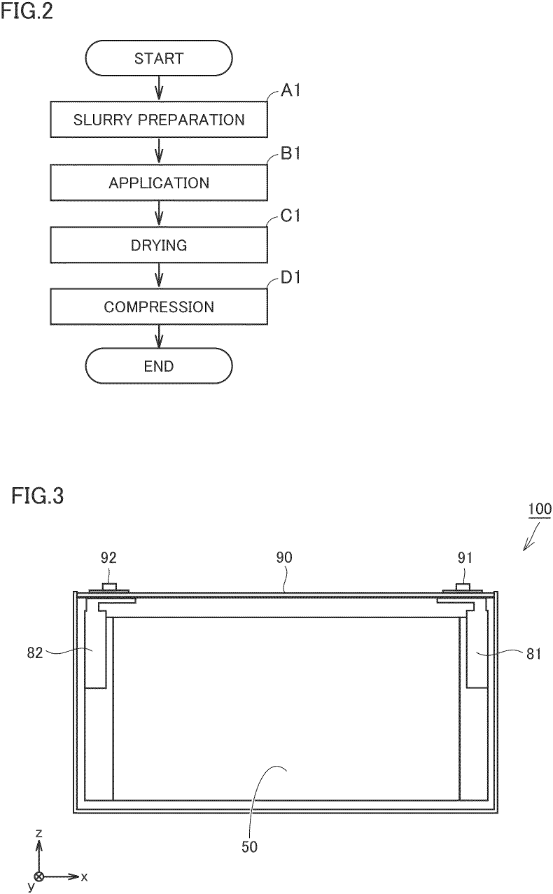

The method of producing positive electrode 10 may include slurry preparation (A1), application (B1), drying (C1), and compression (D1). FIG. 2 is a schematic flowchart showing a method of producing positive electrode 10. The slurry preparation (A1) may include mixing an active material particle, a binder, and an organic solvent. The organic solvent may include, for example, at least one selected from the group consisting of N-methyl-2-pyrrolidone (NMP), tetrahydrofuran (THF), dimethylformamide (DMF), methyl ethyl ketone (MEK), and dimethyl sulfoxide (DMSO). The amount of the organic solvent to be used is not limited. That is, the solid content (which is mass fraction of solid matter) of the slurry is not limited. The slurry may have a solid content from 40% to 80%, for example. For the mixing, any stirring apparatus, any mixing apparatus, and/or any dispersing apparatus may be used.

The application (B1) may include applying the slurry to the surface of a base material to form a coating film. In the present embodiment, the slurry may be applied to the surface of a base material with the use of any applicator. For example, a slot die coater, a roll coater, and/or the like may be used. The applicator may be capable of multilayer application.

The drying (C1) may include heating the coating film to dryness. In the present embodiment, any drying apparatus may be used as long as it is capable of heating the coating film. For example, a hot-air dryer and/or the like may be used to heat the coating film. Heating the coating film allows the organic solvent to evaporate. By this, the organic solvent may be substantially removed.

The compression (D1) may include compressing the dried coating film to form positive electrode active material layer 12. In the present embodiment, any compressing apparatus may be used. For example, a rolling mill and/or the like may be used. The dried coating film may be compressed to form positive electrode active material layer 12, and thereby positive electrode 10 is completed. Positive electrode 10 may be cut into a predetermined planar size depending on the specifications of the battery. Positive electrode 10 may be cut into a belt-like planar shape, for example. Positive electrode 10 may be cut into a rectangular planar shape, for example.

### Battery

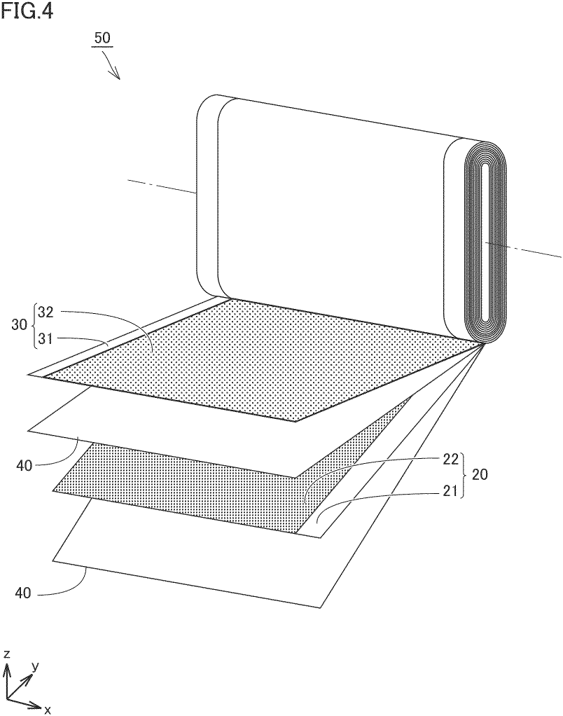

FIG. 3 is a schematic view of an example of a battery according to the present embodiment. The battery may be a non-aqueous electrolyte secondary battery. A battery 100 in FIG. 3 includes an exterior package 90. Exterior package 90 accommodates an electrode assembly 50 and an electrolyte (not illustrated). Electrode assembly 50 is connected to a positive electrode terminal 91 via a positive electrode current-collecting member 81. Electrode assembly 50 is connected to a negative electrode terminal 92 via a negative electrode current-collecting member 82. FIG. 4 is a schematic view of an example of an electrode assembly according to the present embodiment. Electrode assembly 50 is a wound-type one. Electrode assembly 50 includes a positive electrode 20, a separator 40, and a negative electrode 30. That is, battery 100 includes positive electrode 20. Positive electrode 20 includes a positive electrode active material layer 22 and a positive electrode base material 21. Negative electrode 30 includes a negative electrode active material layer 32 and a negative electrode base material 31.

### EXAMPLES

In the following, the present disclosure will be further described in detail by way of Examples. “%” and “part(s)” in Examples refer to mass% and part(s) by mass, respectively, unless otherwise specified.

### Example 1 to Example 7, and Comparative Example 1 to Comparative Example 5

### (Preparation of Positive Electrode Active Material)

Lithium-nickel composite oxide (LiNi_{0.85}Co_{0.1}Mn_{0.5}O₂) was calcined in an air atmosphere to prepare layered metal oxides 1 to 9. The calcination temperature is specified in Table 1. In the present example, when the calcination temperature A is the lowest temperature and the calcination temperature H is the highest temperature, the relationship of A<B<C<D<E<F<G<H was satisfied.

Each of layered metal oxides 1 to 9 included an aggregated particle (a secondary particle) consisting of primary particles. The particle size distributions (D50) of aggregated particle of layered metal oxides 1 to 9 were substantially the same without any significant difference between them. The crystallite diameter was calculated from the half width of the diffraction line of (003) plane measured by X-ray analysis (XRD), by using the Scherrer equation (i). The crystallite size is given in Table 1. The crystallite diameter depended on the calcination temperature, and it tended to increase as the calcination temperature became higher.

### (Preparation of Positive Electrode)

As the material of a positive electrode, a conductive material (carbon black), a binder (PVdF), a dispersion medium (N-methyl-2-pyrrolidone), a positive electrode base material (Al foil), and a tab terminal (an Al thin plate) were prepared. 97.6 parts by mass of the positive electrode active material, 1.5 parts by mass of the conductive material, 0.9 parts by mass of the binder, and a predetermined amount of the dispersion medium were mixed to prepare a positive electrode active material layer slurry. A second positive electrode active material layer slurry was applied to one side of a base material to form a second coating film, and on top of this, a first positive electrode active material layer slurry was applied to form a first coating film.

The first coating film and the second coating film were compressed with the use of a rolling mill to form a first positive electrode active material layer (an upper layer) and a second positive electrode active material layer (a lower layer). Thus, a positive electrode raw sheet was produced. The positive electrode raw sheet was cut into a predetermined size to produce a positive electrode. To the positive electrode, the tab terminal was bonded. The combination of positive electrode active materials in the first positive electrode active material layer and in the second positive electrode active material layer are shown in Table 1.

### (Production of Test Cell (Non-Aqueous Electrolyte Secondary Battery))

As the material of a negative electrode, a negative electrode active material (graphite), a binder (CMC, SBR), a dispersion medium (water), a negative electrode base material (Cu foil), and a tab terminal (Ni thin plate) were prepared. 98 parts by mass of the negative electrode active material, 1 part by mass of CMC, 1 part by mass of SBR, and a predetermined amount of the dispersion medium were mixed to prepare a negative electrode slurry. The resulting negative electrode slurry was applied to the surface of a negative electrode base material, followed by drying, and thereby a negative electrode active material layer was formed. The negative electrode active material layer was compressed with the use of a rolling mill. Thus, a negative electrode raw sheet was produced. The resulting negative electrode raw sheet was cut into a predetermined size to produce a negative electrode. To the negative electrode, the tab terminal was bonded.

As a separator, a polyolefin porous sheet was prepared. The positive electrode, the separator, and the negative electrode were stacked so that the separator was interposed between the positive electrode and the negative electrode. Thus, an electrode assembly was formed. As an exterior package, a pouch made of Al-laminated film was prepared. The electrode assembly was placed inside the exterior package. An electrolyte solution was prepared. The electrolyte solution included a solvent [EC/EMC = 3/7 (volume ratio)], a supporting electrolyte [LiPF₆ (1 mol/L)], and an additive [VC (in a mass fraction of 0.3%)]. The electrolyte solution was injected into the exterior package. The exterior package was hermetically sealed. In this manner, a test cell was produced.

In an environment at a temperature of 25° C., initial charge and discharge was carried out. At a current of 0.2 mA/cm², until the positive electrode potential reached 4.3 V (vs. Li⁻/Li), the test cell was charged in a constant-current mode. Then, until the current reached 0.04 mA/cm², the test cell was charged in a constant-voltage mode. In this way, initial charged capacity was measured. After 10 minutes of resting, at a current of 0.2 mA/cm², until the positive electrode potential reached 2.6 V (vs. Li⁺/Li), the test cell was discharged in a constant-current mode. In the present example, substantially the same level of specific capacity was observed for all the test cells. The value of current [mA/cm²] in the present example had been normalized by the area of the positive electrode.

### (Initial Efficiency)

The test cell was slightly charged and then subjected to activation treatment, followed by discharging. After the discharging, until designed upper and lower voltage limits were reached, charge and discharge were performed. The capacity during this charging is defined as initial charge capacity, and the capacity during this discharging is defined as initial discharge capacity. Initial efficiency was calculated as the ratio of initial discharge capacity to initial charge capacity. The SOC (state of charge) of the test cell was adjusted to 50%. The SOC in the present example refers to the percentage of the charged capacity at a point of time in question relative to the initial discharged capacity. After the SOC adjustment, the test cell was discharged. The charged capacity was divided by the discharged capacity to calculate the initial efficiency. In the present example, a value of 89% or more was rated as “Good”, and a value less than 89% was rated as “Poor”. The initial efficiency is shown in Table 1 below.

### (Capacity Retention)

The SOC of the test battery was adjusted to 100%. After the SOC adjustment, 400 cycles of charge and discharge were carried out while the battery was stored in a thermostatic chamber at 60° C. In order to measure capacity every 50 cycles of charge and discharge, one cycle of charge and discharge was performed at a rate lower than the test rate and the capacity was measured, and then charging was performed at the low rate until the upper limit voltage of the cell specifications was reached. After the charging, the rate was returned to the test rate, followed by another 50 cycles of charge and discharge. This procedure was repeated until the number of test cycles of charge and discharge reached 400 cycles (this number did not include the charge-discharge cycles performed for the purpose of capacity checking). From the discharged capacity before and after the test, capacity retention was calculated. The SOC of the test battery was adjusted to 95% (400 C). After the SOC adjustment, the test battery was stored for 60 days in a thermostatic chamber set at 60° C. Before and after the storage, the discharged capacity of the test battery was measured. From the discharged capacity before and after the storage, capacity retention was calculated. In the present example, a value of 89% or more was rated as “Good”, and a value of less than 89% was rated as “Poor”. The capacity retention is shown in Table 1.

TABLE 1

| | Crystallite diameter (Å) | | Difference in crystallite diameter (Å) | Type of positive electrode active material | | Material calcination temperature | | Initial efficiency | Capacity retention |
|---|---|---|---|---|---|---|---|---|---|
| | Upper layer | Lower layer | | Upper layer | Lower layer | Upper layer | Lower layer | | |
| Comp. Ex. 1 | 1300 | 1300 | 0 | Layered metal oxide 2 | Layered metal oxide 2 | B | B | Poor | Good |
| Comp. Ex. 2 | 1300 | 1400 | 100 | Layered metal oxide 2 | Layered metal oxide 3 | B | C | Poor | Good |
| Comp. Ex. 3 | 1300 | 1900 | 600 | Layered metal oxide 2 | Layered metal oxide 7 | B | G | Good | Poor |
| Comp. Ex. 4 | 1200 | 1300 | 100 | Layered metal oxide 1 | Layered metal oxide 2 | A | B | Poor | Good |
| Comp. Ex. 5 | 1400 | 2000 | 600 | Layered metal oxide 3 | Layered metal oxide 8 | C | H | Good | Poor |
| Ex. 1 | 1300 | 1500 | 200 | Layered metal oxide 2 | Layered metal oxide 4 | B | D | Good | Good |
| Ex. 2 | 1300 | 1600 | 300 | Layered metal oxide 2 | Layered metal oxide 5 | B | E | Good | Good |
| Ex. 3 | 1300 | 1800 | 500 | Layered metal oxide 2 | Layered metal oxide 6 | B | F | Good | Good |
| Ex. 4 | 1200 | 1400 | 200 | Layered metal oxide 1 | Layered metal oxide 3 | A | C | Good | Good |
| Ex. 5 | 1200 | 1500 | 300 | Layered metal oxide 1 | Layered metal oxide 4 | A | D | Good | Good |
| Ex. 6 | 1400 | 1800 | 400 | Layered metal oxide 3 | Layered metal oxide 6 | C | F | Good | Good |
| Ex. 7 | 1400 | 1900 | 500 | Layered metal oxide 3 | Layered metal oxide 7 | C | G | Good | Good |

In the present example, when both the initial efficiency and the capacity retention are rated as “Good”, it is regarded that both the output properties and the endurance are obtained. As shown in Table 1 above, Example 1 to Example 7 have both the initial efficiency and the capacity retention.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

The embodiments and examples disclosed herein are illustrative and non-restrictive in any respect. The technical scope indicated by the claims encompasses any modifications within the scope and meaning equivalent to the terms of the claims.

What is claimed is:

1. A positive electrode comprising:
a positive electrode active material layer; and
a positive electrode base material, wherein
the positive electrode active material layer includes a positive electrode active material,
the positive electrode active material includes a layered metal oxide,
a ratio of nickel to metallic elements except lithium in the layered metal oxide is 70 mol % or more, and
a part of the positive electrode active material present near a surface of the positive electrode active material layer closer to the positive electrode base material has a crystallite diameter that is 200 Å to 500 Å greater than a part of the positive electrode active material present near a surface of the positive electrode active material layer opposite to the positive electrode base material.

2. The positive electrode according to claim 1, wherein the layered metal oxide is represented by a formula (1):
$${\text{Li}}_{\text{1-a}} {\text{Ni}}_{\text{x}} {\text{Me}}_{\text{1-x}} {\text{O}}_{2} \qquad \text{(1)}$$
where
a satisfies a relationship of -0.3≤a≤0.3,
X satisfies a relationship of 0.7≤x≤1.0, and
Me stands for at least one selected from the group consisting of Co, Mn, Al, Zr, B, Mg, Fe, Cu, Zn, Sn, Na, K, Ba, Sr, Ca, W, Mo, Nb, Ti, Si, V, Cr, and Ge.

3. The positive electrode according to claim 1, wherein the positive electrode active material layer includes a first positive electrode active material layer and a second positive electrode active material layer, and the second positive electrode active material layer is positioned close to the positive electrode base material as compared to the first positive electrode active material layer.

4. The positive electrode according to claim 3, wherein a thickness of the second positive electrode active material layer is defined as T2, a thickness of the first positive electrode active material layer is defined as T1, and a ratio of T1 to T2 (T1/T2) is from 0.33 to 3.0.

5. A battery comprising the positive electrode according to claim 1.
